(19) United States
(12) Patent Application Publication
(10) Pub. No.: US 2025/0261585 A1
(43) Pub. Date: Aug. 21, 2025

(54) FORMING SHIELD FOR A HARVESTING IMPLEMENT

(71) Applicant: MACDON INDUSTRIES LTD., Winnipeg (CA)

(72) Inventors: Matthew James Stephens, Niverville (CA); Kirk Kevin Calvadores, West St Paul (CA)

(21) Appl. No.: 19/055,290

(22) Filed: Feb. 17, 2025

Related U.S. Application Data
(60) Provisional application No. 63/554,688, filed on Feb. 16, 2024.

(51) Int. Cl. A01D 34/125; A01D 34/04; A01D 34/14; A01D 34/40

(52) U.S. Cl. CPC A01D 34/125; A01D 34/046; A01D 34/14; A01D 34/40

(57) ABSTRACT

A crop harvesting header including a carrier frame configured to be mounted to a tractor to cut crop. The crop harvesting header includes a header frame movably coupled to the carrier frame and defining a discharge opening on a rear side. The crop harvesting header further includes a discharge shaper assembly, which includes a height deflector. The height deflector is pivotably coupled to the header frame adjacent to the discharge opening to control a height of discharged cut crop. The discharge shaper assembly may further include a width deflector to control a width of discharged cut crop.

### CROSS-REFERENCE TO RELATED APPLICATIONS

The subject patent application claims priority to, and all the benefits of, U.S. Provisional Patent Application No. 63/554,688, filed on Feb. 16, 2024, the entire contents of which are incorporated by reference herein.

### BACKGROUND

Crop harvesting headers are typically classified as a pull-type, being pulled behind a tractor to harvest crops, or a push-type, being coupled to the front of a tractor and pushed. Each arrangement has certain advantages depending on the type of crop being harvested. Some crops are formed into windrows by the harvesting header to be collected by a separate machine. In general, a harvesting header having a greater width is able to process crops at a greater rate than a harvesting header having a narrower width. For this reason, a wide harvesting header is advantageous. In order to avoid running over discharged crops with the wheels of the tractor, a specialized windrowing tractor with widely spaced wheels is commonly used in combination with a front mounted harvesting header. The harvesting header may also be mounted to the front of a conventional tractor. However, the wheel spacing of a conventional tractor is typically narrower than a windrowing tractor and the frame height of a conventional tractor is typically lower than the frame height of a windrowing tractor. As such, the wheels and/or frame of the conventional tractor are subject to interfering with the cut crops discharged from the harvesting header. Therefore, it is desirable to shape the cut crop as it is discharged from the header to flow beneath the tractor.

### SUMMARY

In one aspect, a crop harvesting header is operable to form harvested crops into windrows. The crop harvesting header may include a carrier frame, a header frame, and a cutter bar. The carrier frame is configured to be mounted to a tractor during use. The header frame is movably coupled to the carrier frame and a discharge opening is defined on a rear side of the header frame. The cutter bar is coupled to the header frame and operable to cut crops. The crop harvesting header further includes a discharge shaper assembly. The discharge shaper assembly includes a height deflector coupled to the header frame adjacent to the discharge opening. The height deflector is pivotable to control a height of a windrow formed from crops ejected through the discharge opening during operation.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a first environmental view showing a front perspective of a harvesting header mounted to the front of a tractor.

FIG. 2 is another environmental view showing a rear perspective of the harvesting header of FIG. 1 mounted to the front of a tractor.

FIG. 3 is another environmental view showing a side view of the harvesting header of FIG. 1 mounted to a tractor and harvested crop being formed into a windrow and discharged from the harvesting header.

FIG. 4 is another environmental view showing a top view of the harvesting header and tractor of FIG. 3 with harvested crop being formed into a windrow and discharged from the harvesting header below the tractor.

FIG. 5 is another environmental view showing a bottom view of the harvesting header and tractor of FIG. 1.

FIG. 6 is another environmental view showing a bottom perspective of the harvesting header and tractor of FIG. 5.

FIG. 7 is an enlarged side view of the harvesting header and tractor of FIG. 3 with the harvesting header shown in a harvest position.

FIG. 8 is an enlarged side view of the harvesting header and tractor of FIG. 7 with the harvesting header shown in a transport position.

FIG. 9 is rear perspective view of the harvesting header removed from the tractor showing a header frame, a carrier frame, and a discharge shaper.

FIG. 10 is a side view of the harvesting header of FIG. 9.

FIG. 11 is a cross-sectional side view of the harvesting header showing the header frame, the carrier frame, the discharge shaper, a cutter bar, and a pair of conditioner rolls.

FIG. 12 is a top side view of the harvesting header of FIG. 9.

FIG. 13 is a rear side view of the harvesting header of FIG. 9 with the conditioner rolls removed.

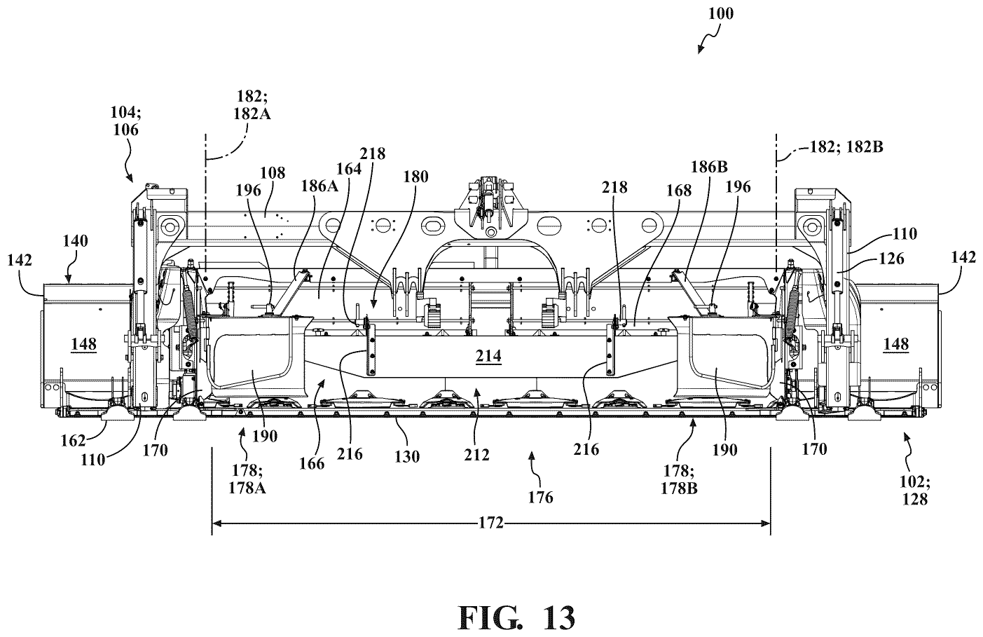

FIG. 14 is a bottom perspective view of the harvesting header of FIG. 9.

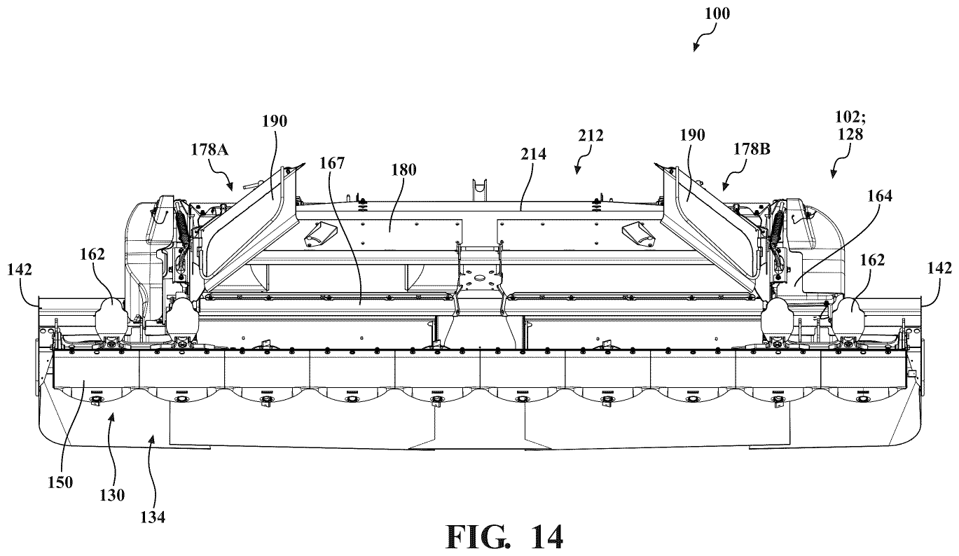

FIG. 15 is a bottom side view of the harvesting header of FIG. 9.

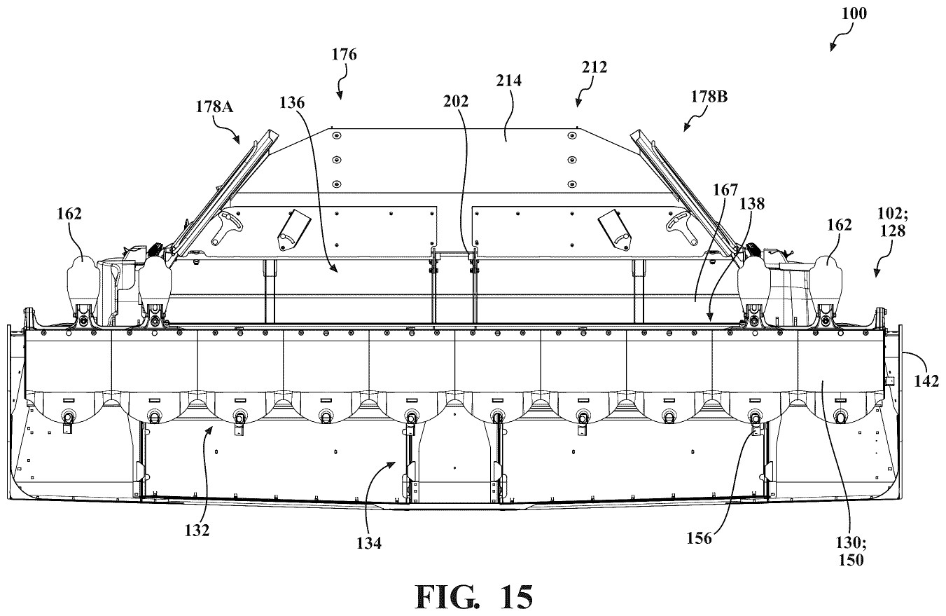

FIG. 16 is a cross-sectional front view of the harvesting header with the conditioner rolls removed showing the header frame having a discharge opening and the discharge shaper.

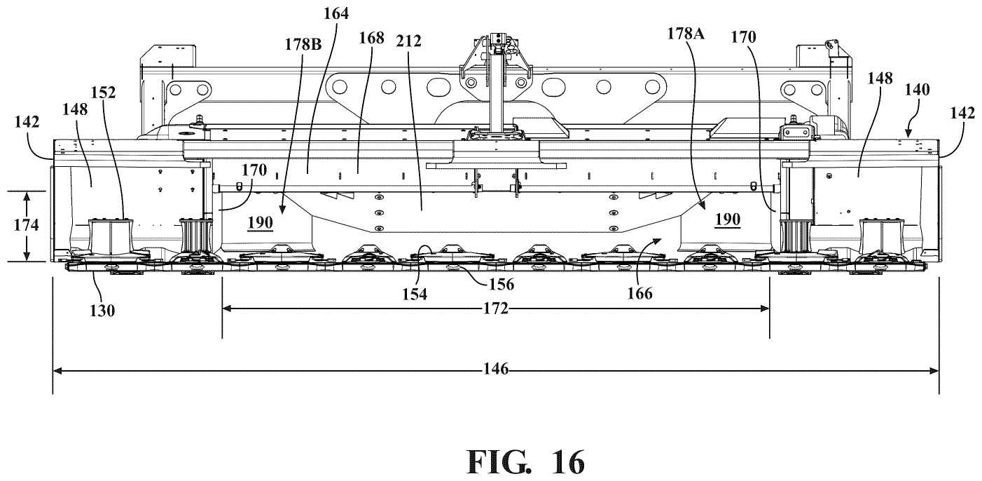

FIG. 17 is a fragmentary cross-sectional perspective view of the harvesting header showing the header frame and the discharge shaper.

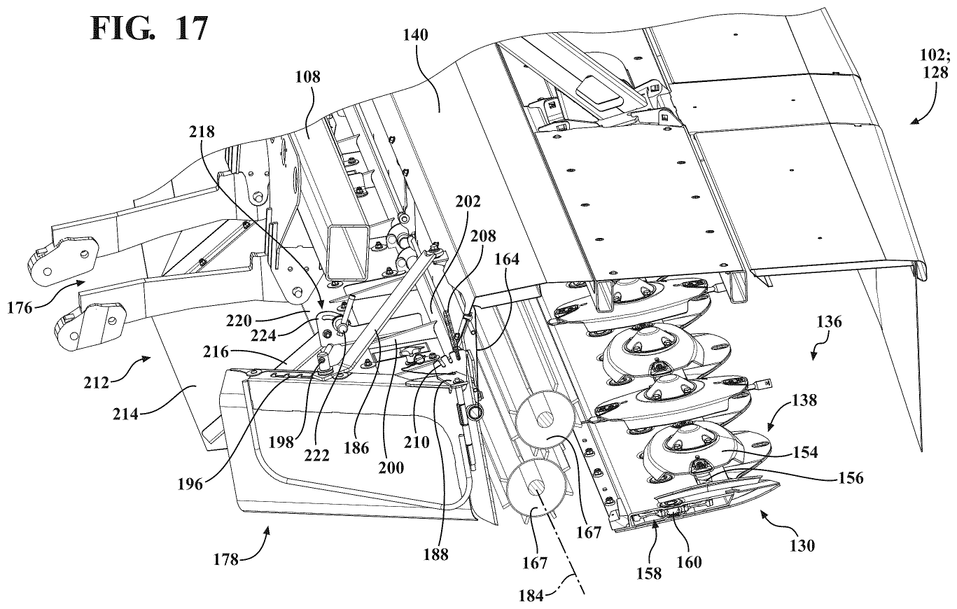

FIG. 18 is another fragmentary cross-sectional perspective view of the harvesting header showing the header frame, the cutter bar, and the discharge shaper.

FIG. 19 is another cross-sectional perspective view of the harvesting header showing the header frame, the cutter bar, and the discharge shaper.

FIG. 20 is yet another cross-sectional perspective view of the harvesting header showing the header frame, the cutter bar, and the discharge shaper.

### DETAILED DESCRIPTION

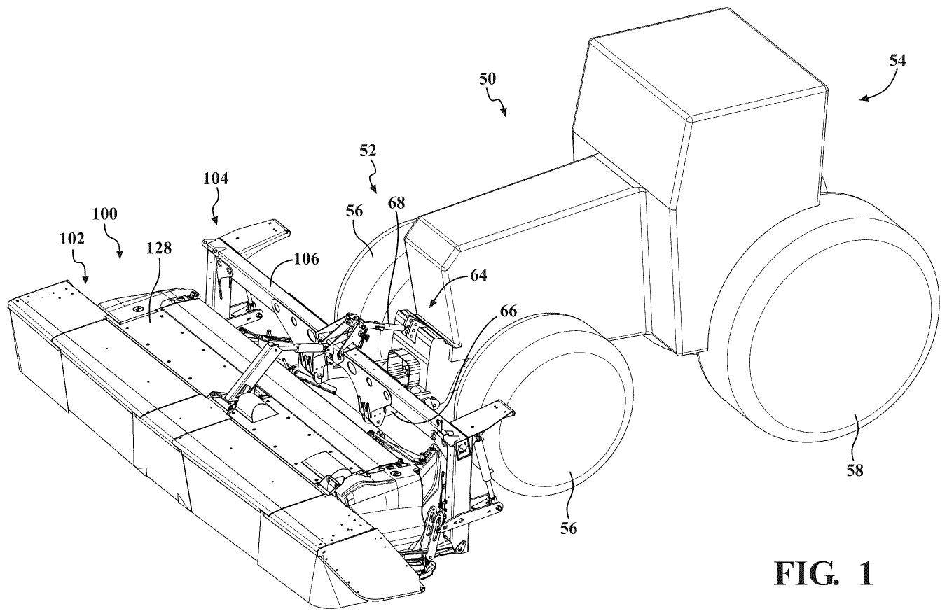

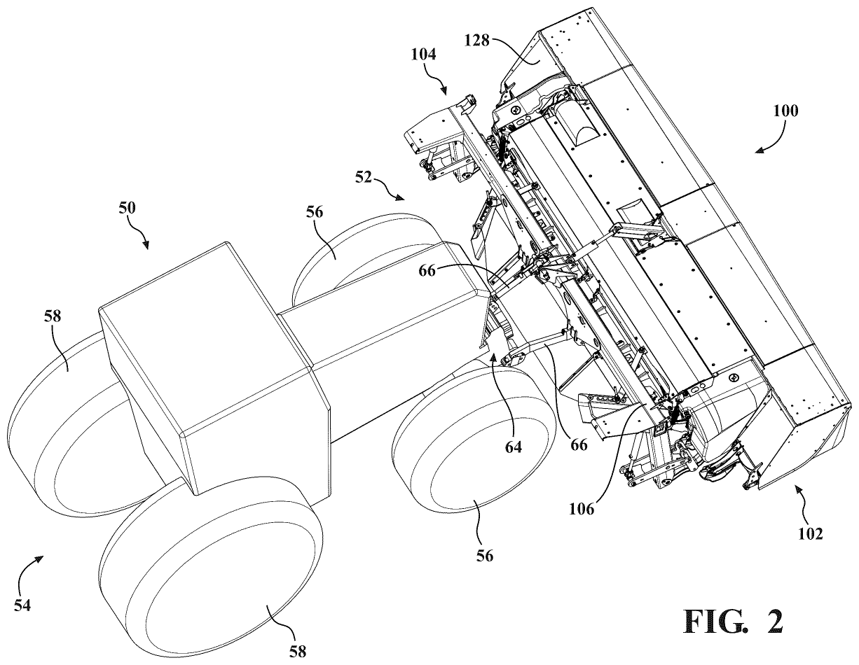

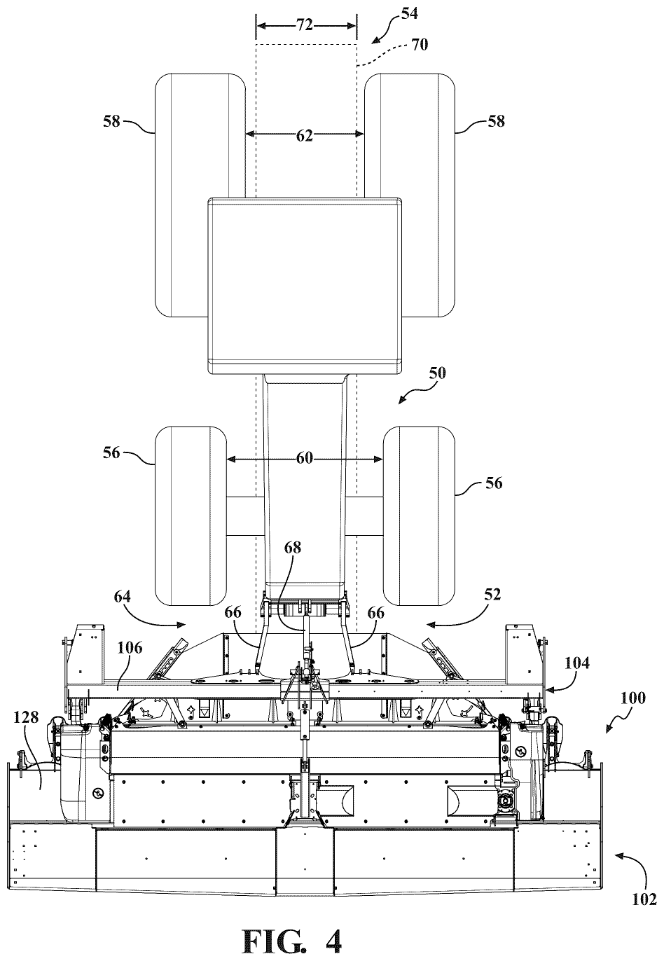

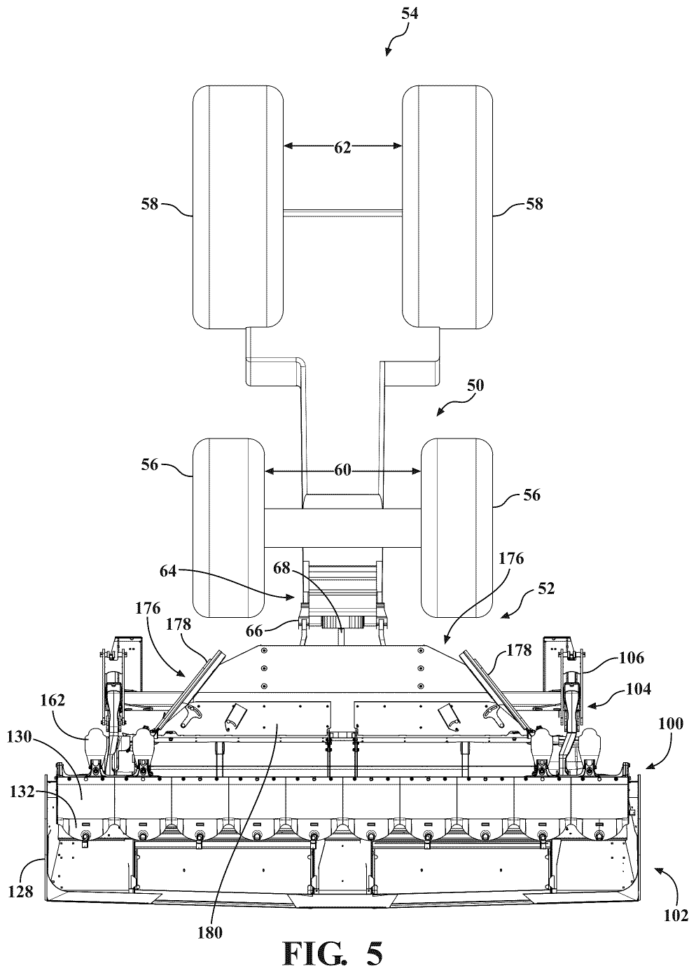

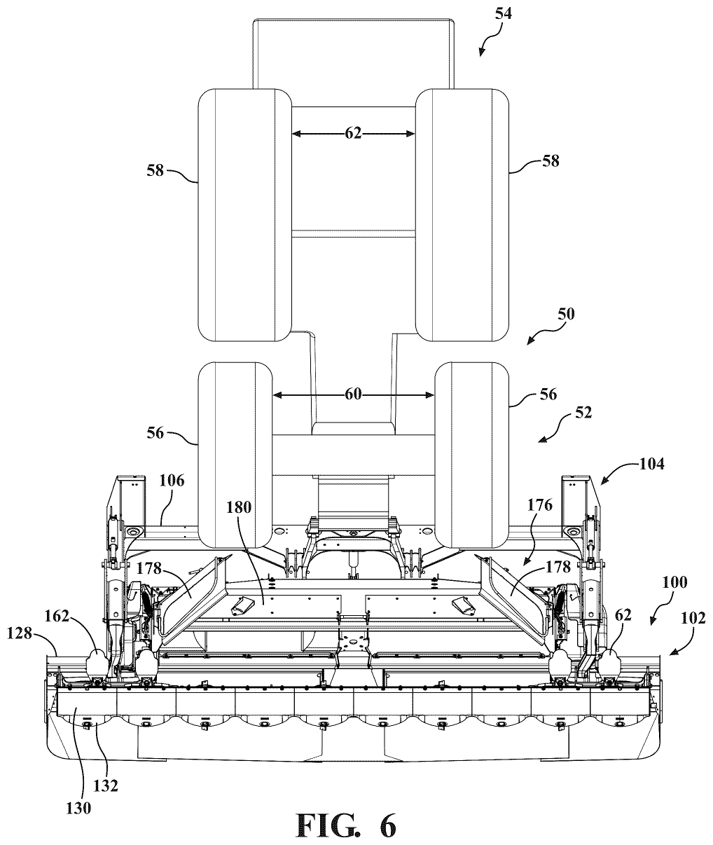

In FIGS. 1-6, an implement 100 for harvesting crops is shown coupled to a traditional style tractor 50. In general, the tractor 50 has a front 52 and a rear 54 associated with forward and reverse directions of travel. The tractor 50 illustrated herein comprises front wheels 56 and rear wheels 58 arranged proximate the corresponding front 52 and rear 54 thereof. It will be appreciated that the tractor 50 may be configured as shown with wheels, or may utilize other propulsion configurations such as tracks, or a combination of tracks and wheels (not shown). Best shown in FIGS. 4 and 5, each of the front wheels 56 is arranged on one side of the tractor 50 and laterally spaced from the other. The front wheels 56 are laterally spaced from each other by a first wheel width 60. Similarly, each of the rear wheels 58 is arranged on one side of the tractor 50 and laterally spaced from the other. The rear wheels 58 are laterally spaced from each other by a second wheel width 62. Said differently, the first wheel width 60 and the second wheel width 62 define the clearance between inner sides of each of the front wheels 56 and each of the rear wheels 58, respectively. The first wheel width 60 and the second wheel width 62 vary according to the model of the tractor 50, as well as the configuration of the tractor 50. For example, some tractors 50 may be configured with wheels that are arranged in pairs or triples (not shown), and may have first and second wheel widths 60, 62 that are less than are illustrated herein. Furthermore, wheels of differing widths may be utilized depending on the type of crops that are being harvested or the type of terrain being traversed. Similarly, a tractor 50 configured with tracks (not shown) may have a wheel width that is greater than illustrated herein.

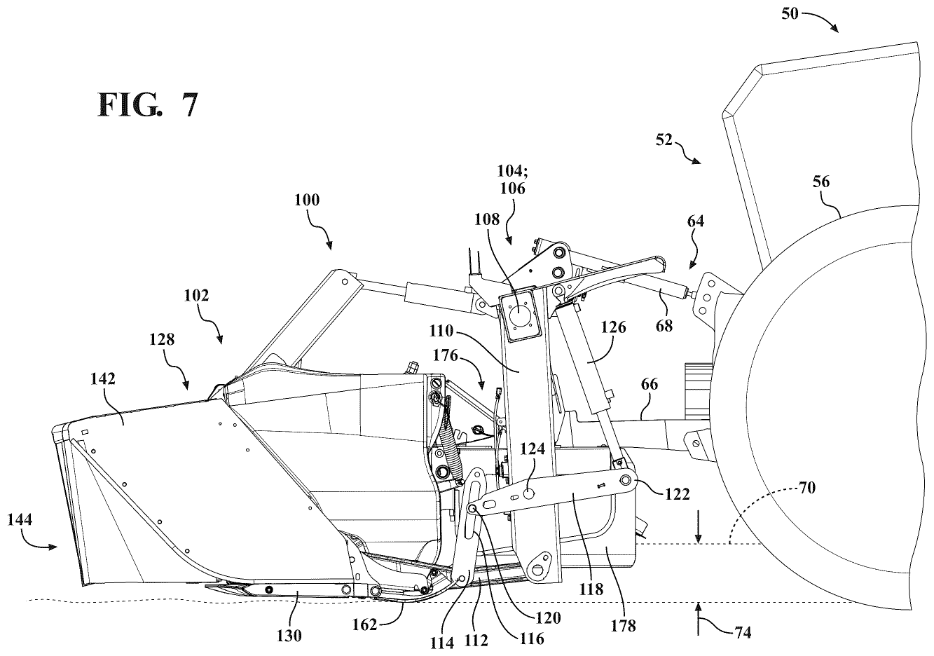

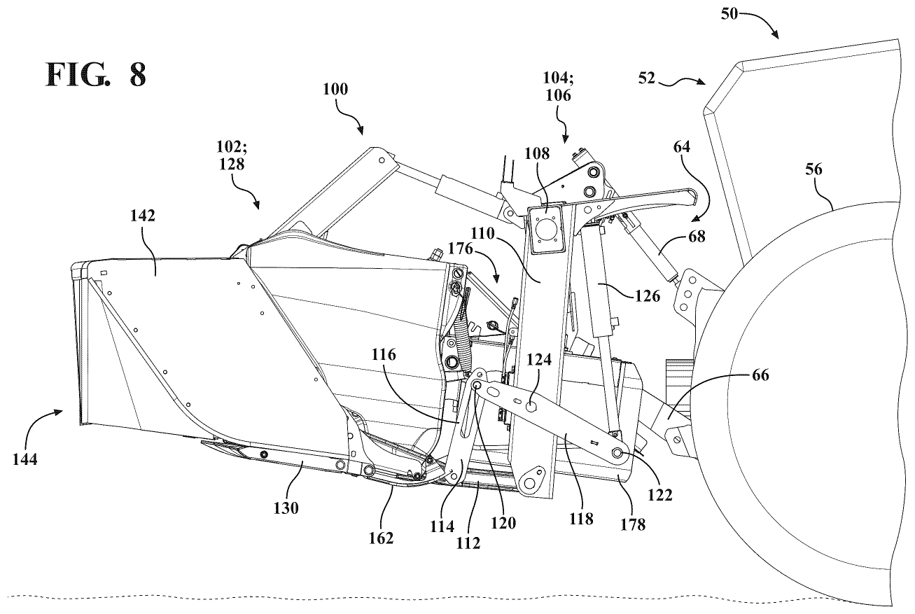

The tractor 50 is used to operate and control the implement 100 by providing power, via a tractor PTO system. A hydraulic system pumps hydraulic fluid to the implement 100, which is utilized to actuate and control various components of the implement 100, as will be discussed below. The tractor 50 further comprises a hitch 64 arranged at the front 52 to couple the implement 100 to the tractor 50. Here, the hitch 64 is a three-point hitch, which comprises a pair of lifting arms 66 and a top link 68. The lifting arms 66 may be powered by the hydraulic system to pivot between a raised position (FIG. 8) and a lowered position (FIG. 7) for controlling a height of the implement 100 above the ground. The top link 68 controls the angle of the implement 100 as it is lifted and lowered, and typically has an adjustable length which may be controlled manually or hydraulically. The lifting arms 66 carry the harvesting implement 100 and are controllable by an operator to raise or lower the harvesting implement 100 during use.

The harvesting implement 100 illustrated herein is a rotary mower 100. The rotary mower 100 includes a header 102 and a carrier 104. The carrier 104 is coupled or mounted to the hitch 64 of the tractor 50 and supports the header 102 during operation. The header 102 is movably coupled to the carrier 104 to facilitate independent movement of the header 102 relative to the carrier 104 and the tractor 50. During use, the header 102 is pushed along the ground by the tractor 50 and is able to float relative to the carrier 104 and closely follow contours of the ground to maintain a steady height above the ground. The floating action of the header 102 allows the header 102 to move independently of the tractor 50 such that movement of the tractor 50 does not influence the height of the header 102, which facilitates consistent cut height when harvesting crops. Crops that have been cut by the rotary mower 100 are discharged at a rear of the header 102 into a windrow 70 for later collection.

As mentioned above, the rotary mower 100 includes the carrier 104. The carrier 104 includes a carrier frame 106 having a base member 108 and two side members 110 arranged on opposing ends of the base member 108. The carrier 104 further includes a pair of float links 112 each pivotably coupled to one of the side members 110 and to the rotary mower 100. The float links 112 control the relative movement between the header 102 and the carrier frame 106. The carrier 104 further includes a sliding link 114 and a limiter link 118. The sliding link 114 is pivotably coupled to one of the float links 112 and defines a guide slot 116. The limiter link 118 has a first end 120 and a second end 122 spaced from the first end 120. The first end 120 of the limiter link 118 is movably coupled to the guide slot 116 for pivoting and sliding movement relative to the sliding link 114. Furthermore, the limiter link 118 is pivotably coupled to one of the side members 110 of the carrier frame 106 at a pivot axis 124 between the first end 120 and the second end 122. A lift actuator 126 is coupled between the carrier frame 106 and the second end 122 of the limiter link 118. The lift actuator 126 is movable between a retracted position (FIG. 7) and an extended position (FIG. 8) to effect coordinated movement of the limiter link 118 and the float links 112. In this way, a couple moment is formed by the first end 120 and the second end 122 of the limiter link 118 as it pivots about the pivot axis 124.

Similarly, the header 102 includes a header frame 128, the header frame 128 being coupled to and arranged forwardly of the carrier frame 106 by the float links 112. Said differently, a first end of the float links 112 is coupled to the carrier frame 106 and a second end of the float links 112 is coupled to the header frame 128. The header 102 further includes a cutter bar 130 coupled to the header frame 128. The cutter bar 130 includes a plurality of rotary cutters 132, which are driven by the tractor PTO. The cutter bar 130 is operable to cut crops that are received in the header 102. The header frame 128 has front and rear sides longitudinally spaced along a centerline, and lateral sides arranged opposite one another across the centerline. The header frame 128 has an inlet portion 134 on the front side of the header 102, a discharge portion 136 at the rear side of the header 102, and a cutter portion 138, in which the cutter bar 130 is disposed, arranged between the inlet portion 134 and the discharge portion 136. The header frame 128 further includes a top wall 140 that extends between the inlet portion 134 and the cutter portion 138. During operation, as the rotary mower 100 progresses forward, crops are received in the inlet portion 134 and into the cutter portion 138 where the crops are cut by the cutter bar 130. Cut crops enter the discharge portion 136 and are discharged through the rear side of the header frame 128.

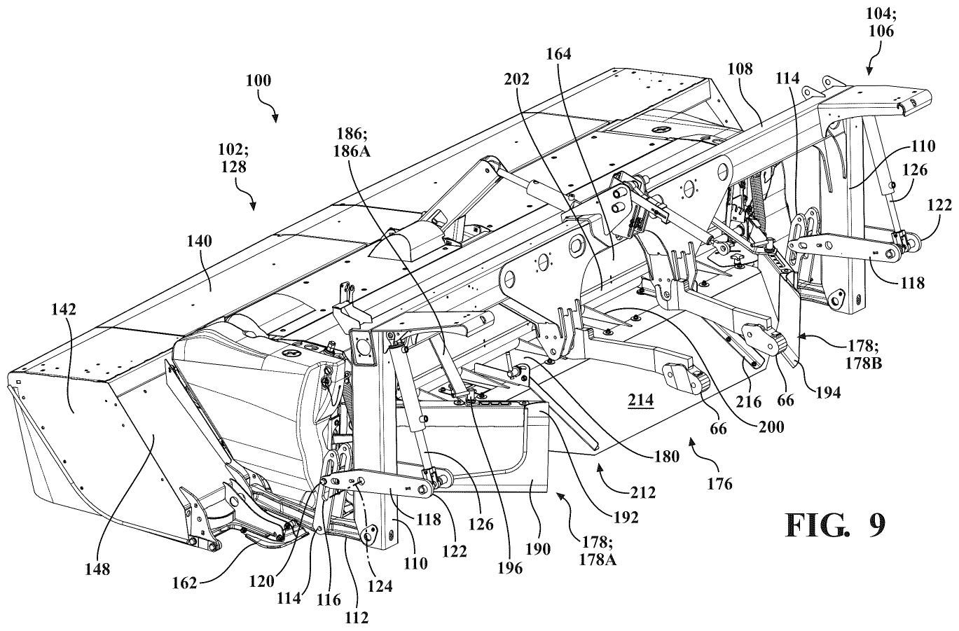

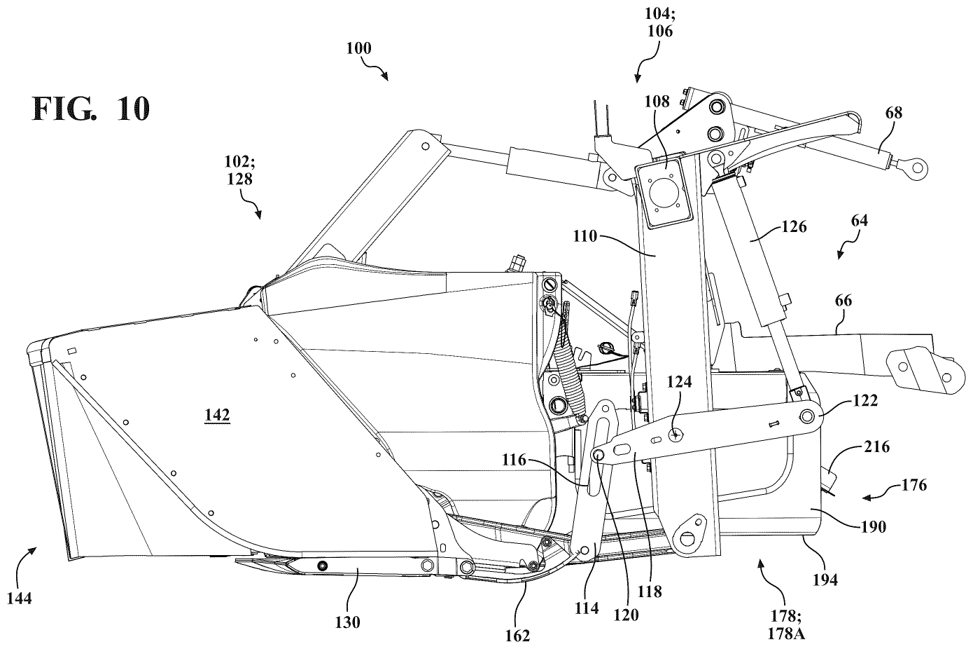

Best shown in FIGS. 9-11, the inlet portion 134 includes two side inlet walls 142 spaced from each other to form an inlet opening 144 having an inlet width 146. The inlet opening 144 is arranged at the frontmost end of the rotary mower 100 and receives uncut crops as the rotary mower 100 is advanced forward by the tractor 50. The header frame 128 may further include rear header walls 148 at a rear of the header frame 128. The rear header walls 148 guide crops processed in the cutter portion 138 toward the discharge portion 136. The side inlet walls 142, the rear header walls 148, and the top wall 140 cooperate to enclose the inlet portion 134 and the cutter portion 138 of the header frame 128. As the tractor 50 continues to advance the rotary mower 100 forward, crops move from the inlet portion 134 into the cutter portion 138.

Crops entering the cutter portion 138 are cut by the rotary cutters 132 of the cutter bar 130. The cutter bar 130 includes a cutter housing 150, which is coupled to the header frame 128. The cutter bar 130 may further include one or more drums 152 coupled to the rotary cutters 132 and configured to direct the cut crop toward the center of the discharge portion 136. Each of the rotary cutters 132 is supported by the cutter housing 150 for rotation during operation and includes a hub 154 and a pair of blades 156 coupled to the hub 154. To this end, the cutter housing 150 defines an interior 158, in which a transmission 160 is disposed. The transmission 160 may comprise one or more gears that transfer rotational motion to the rotary cutters 132 to spin the blades 156 and to one or more drums 152. The transmission 160 may alternatively comprise other mechanical couplings that facilitate the transfer of rotational motion such as a belt and pulleys, a chain and sprockets, or may be a direct drive connection to the rotary cutters 132. The cutter bar 130 may further include one or more float shoes 162, or skid shoes, that are coupled to the cutter housing 150 and support the cutter bar 130 on the ground. The float shoes 162 slide along the ground as the rotary mower 100 is pushed by the tractor 50 and follow the contours of the ground to maintain the height of the rotary cutters 132 relative to the ground.

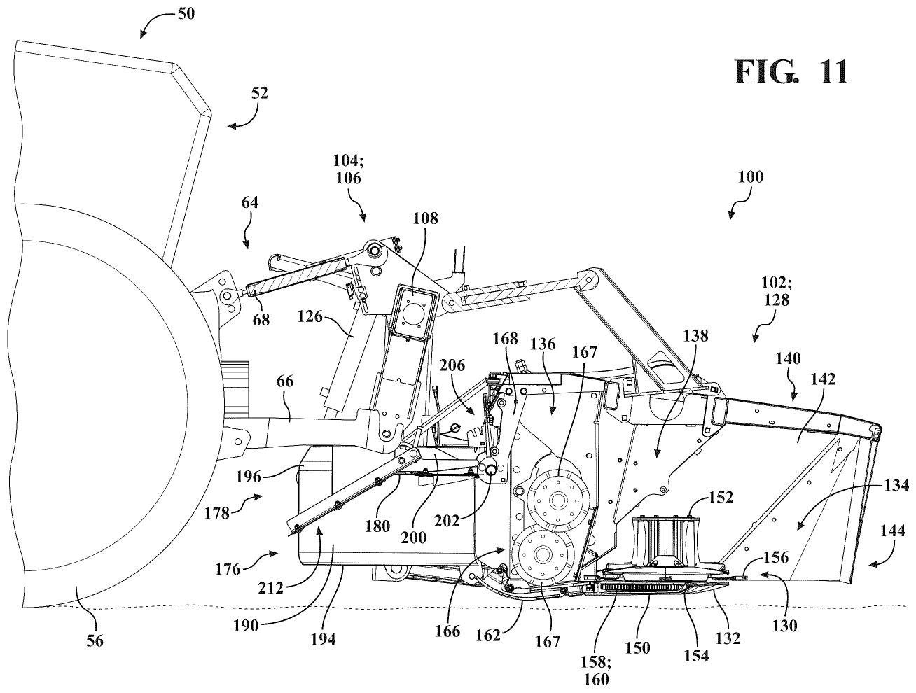

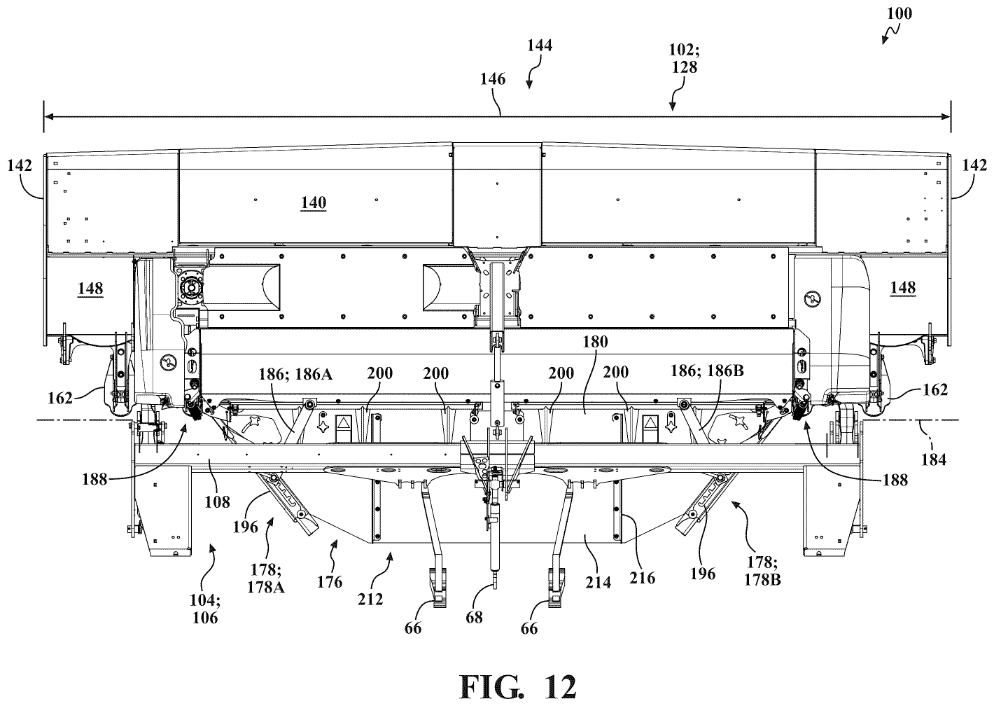

With continued reference to FIGS. 11 and 12, the discharge portion 136 of the header frame 128 is shown. The discharge portion 136 includes a rear discharge wall 164 defining a rear side of the header frame 128. A discharge opening 166 is defined on a rear side of the header frame 128 and in the rear discharge wall 164 and is further arranged centrally on the rear side of the header frame 128. The discharge opening 166 is defined by a horizontal head jamb 168 and two laterally spaced side jambs 170. The discharge opening 166 has a discharge opening width 172 defined by the horizontal distance between the opposing side jambs 170, and a discharge opening height 174 defined by the vertical distance between the cutter bar 130 and the head jamb 168. The discharge opening width 172 is less than the inlet width 146 and the horizontal distances between each of the side jambs 170 and an adjacent one of the side inlet walls 142 is approximately equal.

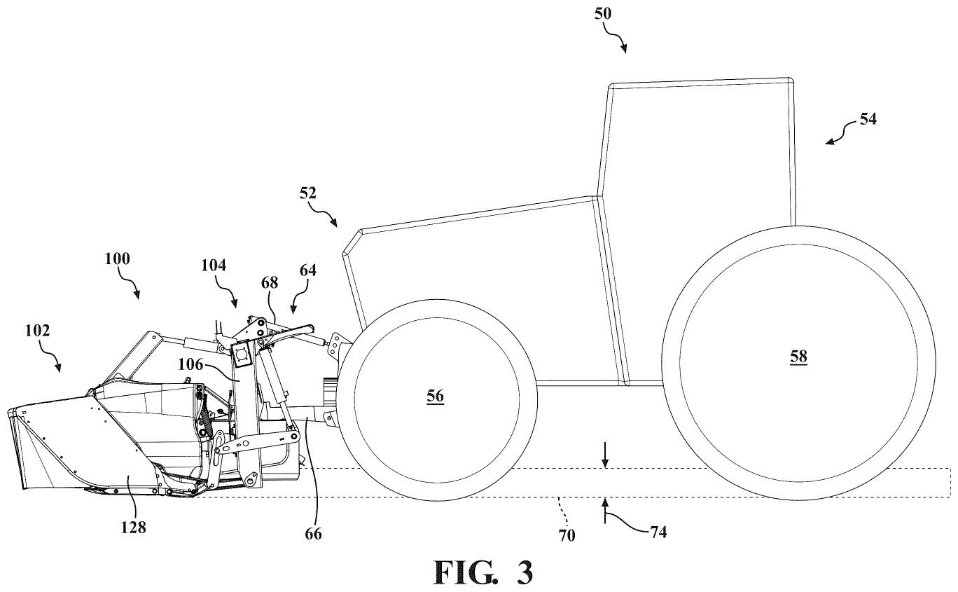

As mentioned above, crops that have been cut in the cutter portion 138 progress into the discharge portion 136 and toward the discharge opening 166 and into a pair of conditioner rolls 167, which eject the cut crop through the discharge opening 166 and out of the rotary mower 100 to form windows 70. The rotary mower 100 is able to cut crops in a path corresponding to the inlet width 146 of the inlet opening 144 and form a windrow 70 having a windrow width 72 and a windrow height 74. In general, increasing the inlet width 146 facilitates harvesting crops at a greater rate. Best shown in FIGS. 3 and 4, the rotary mower 100 cuts crops along the inlet width 146, which is larger than the width of the tractor 50. Because the rotary mower 100 is attached to the front 52 of the tractor 50, crops discharged from the discharge opening 166 pass underneath the tractor 50. In order to prevent discharged crops being run over by the wheels 56, 58 of the tractor 50, the windrow width 72 should be less than the width between the wheels 56, 58 of the tractor 50. Said differently, the windrow width 72 should be less than both the first wheel width 60 and the second wheel width 62. Additionally, the windrow height 74 should be less than the distance between the ground and the lowest point, typically the frame, of the tractor 50, i.e., the ground clearance.

In order to accommodate a wide variety of tractors 50, the rotary mower 100 further includes a discharge shaper 176 that forms the cut crops into windrows 70. The discharge shaper 176 is configurable to control and adjust the windrow width 72 and the windrow height 74. The discharge shaper 176 is configurable by a user to form a windrow 70 having a windrow width 72 less than the first wheel width 60 and the second wheel width 62. The discharge shaper 176 is further configurable by a user to form a windrow 70 having a windrow height 74 less than the ground clearance of the tractor 50. As mentioned above, the cut crop is guided into the conditioner rolls 167. The conditioner rolls 167 add energy to the cut crop that is ejected into the discharge shaper 176. The ejected cut crop is guided by the discharge shaper 176 and formed into a windrow.

To this end, the discharge shaper 176 is coupled to the header frame 128 and extends rearwardly toward the carrier frame 106. The discharge shaper 176 extends rearwardly beyond the carrier frame 106 to a distance further from the header frame 128 than the carrier frame 106. The discharge shaper 176 may include a width deflector 178 and a height deflector 180. Both the width deflector 178 and the height deflector 180 are pivotably coupled to the header frame 128 adjacent to the discharge opening 166. The width deflector 178 and the height deflector 180 cooperate to form the cut crops into a windrow 70 and control the windrow width 72 and windrow height 74. Specifically, the width deflector 178 controls the windrow width 72 and the height deflector 180 controls the windrow height 74. The width deflector 178 is pivotable about a height axis 182 of the rotary mower 100 and the height deflector 180 is pivotable about a lateral axis 184 of the rotary mower 100. Here, rotary mower 100 may comprise more than one width deflector 178 pivotably coupled to the header frame 128. A first width deflector 178A may be pivotable about a first height axis 182A and a second width deflector 178B may be pivotable about a second height axis 182B. The first width deflector 178A and the second width deflector 178B are arranged adjacent to the discharge opening 166 and on opposing sides of the height deflector 180. Said differently, the first width deflector 178A may be coupled to one of the side jambs 170 of the discharge opening 166 and the second width deflector 178B may be coupled to the other of the side jambs 170 of the header frame 128. Each of the first width deflector 178A and the second width deflector 178B may be constructed from a polymer material such as a rubber or plastic. The rubber material may provide some flexibility to the width deflectors 178A, 178B to avoid over-compressing the cut crops when forming the windrow 70. Additionally, a rubber material is resistant to damage from impacts during operation. The flexibility of the width deflectors 178 and the height deflector 180 facilitates forming the windrow by providing variability to how densely the cut crop will be packed to form the windrow. Said differently, as the discharge shaper 176 forms the cut crop into the windrow, the width deflectors 178 and the height deflector 180 are able to flex, which prevents the cut crop from becoming too densely packed. As will be discussed in greater detail below, the first width deflector 178A and the second width deflector 178B may be pivoted independently of one another to adjust the windrow width 72 as well as the position of the windrow 70 relative to the discharge opening 166. If only one of the width deflectors 178 is adjusted, the position of the windrow 70 will be shifted in a lateral direction (i.e., left and right) relative to the rotary mower 100.

The discharge shaper 176 may further comprise a width limiting arm 186 coupled to the width deflector 178 and the header frame 128. The width limiting arm 186 is configured to adjust the angle of the width deflector 178 to control the windrow width 72. Here, the discharge shaper 176 comprises a first width limiting arm 186A coupled to the first width deflector 178A and a second width limiting arm 186B coupled to the second width deflector 178B. Each of the first width limiting arm 186A and the second width limiting arm 186B is coupled between the header frame 128 and the corresponding width deflector 178A, 178B.

Each of the first width deflector 178A and the second width deflector 178B may include a hinge 188 and a deflector shield 190 coupled to the hinge 188. The hinge 188 is coupled to the rear discharge wall 164 and arranged on the height axis 182 to facilitate the pivoting movement of the corresponding width deflector 178A, 178B. The deflector shield 190 may include an upper wing portion 192 and a lower wing portion 194 spaced from each other to define a C-shaped profile of the deflector shield 190. The C-shaped profile directs cut crops exiting the discharge opening 166 along the deflector shield 190 to form the windrow 70. The C-shaped profile is curved toward the height deflector 180 and facilitates forming the windrows 70 by preventing cut crops from rolling over an upper and lower side of the width deflector 178, which increases efficiency and further prevents cut crops from being run over by the tractor 50.

As mentioned above, the discharge shaper 176 includes the width limiting arms 186A, 186B coupled between the header frame 128 and the corresponding width deflector 178A, 178B. To this end, the upper wing portion 192 of each of the width deflectors 178A, 178B may include a width latch 196 coupled to the corresponding width limiting arm 186A, 186B. Here, the width latch 196 includes a slot with at least one notch, the notch being engageable with the width limiting arm 186 to limit adjustment of the width deflector 178. The width latch 196 may include a clamp 198 that is coupled to the width limiting arm 186 and disposed in the slot. The clamp 198 secures the width limiting arm 186 to the width deflector 178 to prevent relative movement therebetween.

The width limiting arm 186 is movable along a length of the slot of the width latch 196 to adjust the angle of the width deflector 178 relative to the rear discharge wall 164. The at least one notch of the width latch 196 may define a discrete position or angle relative to the rear discharge wall 164 of each of the width deflectors 178A, 178B to facilitate symmetric adjustment. When the first width deflector 178A and the second width deflector 178B are adjusted to the same angle, the windrow 70 will be formed at a centered position relative to the width of the rotary mower 100. If the first width deflector 178A and the second width deflector 178B are adjusted to angles that are different from each other, the windrow 70 will be formed at a position that is off center relative to the width of the rotary mower 100. Generally, the first width deflector 178A and the second width deflector 178B are adjusted symmetrically (i.e., to the same angle), however asymmetric adjustment may permit the windrow width 72 to be more precisely controlled. The clamp 198 is engageable with the at least one notch to set the angle of the width deflector 178.

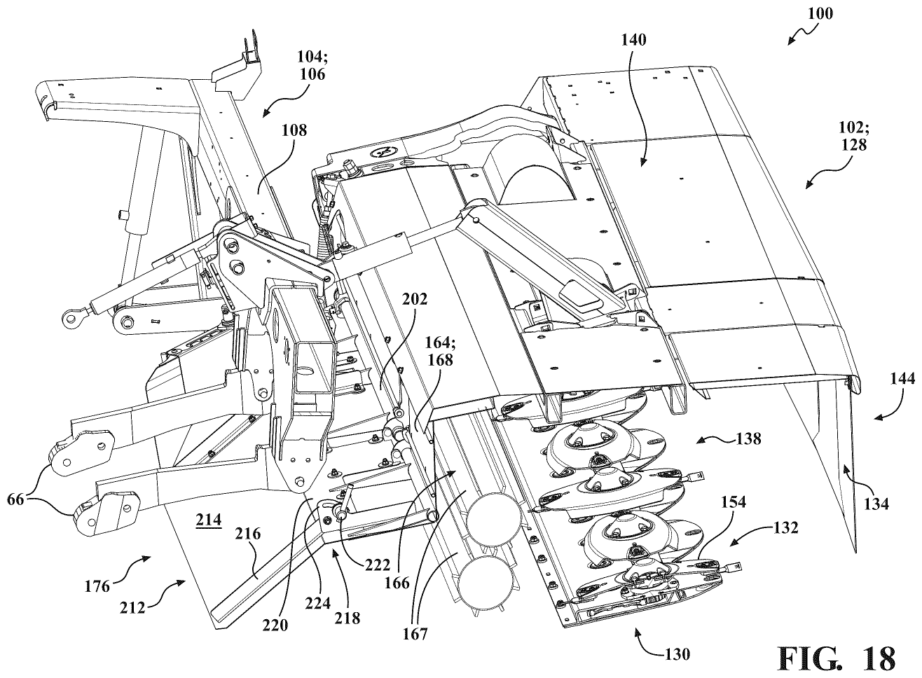

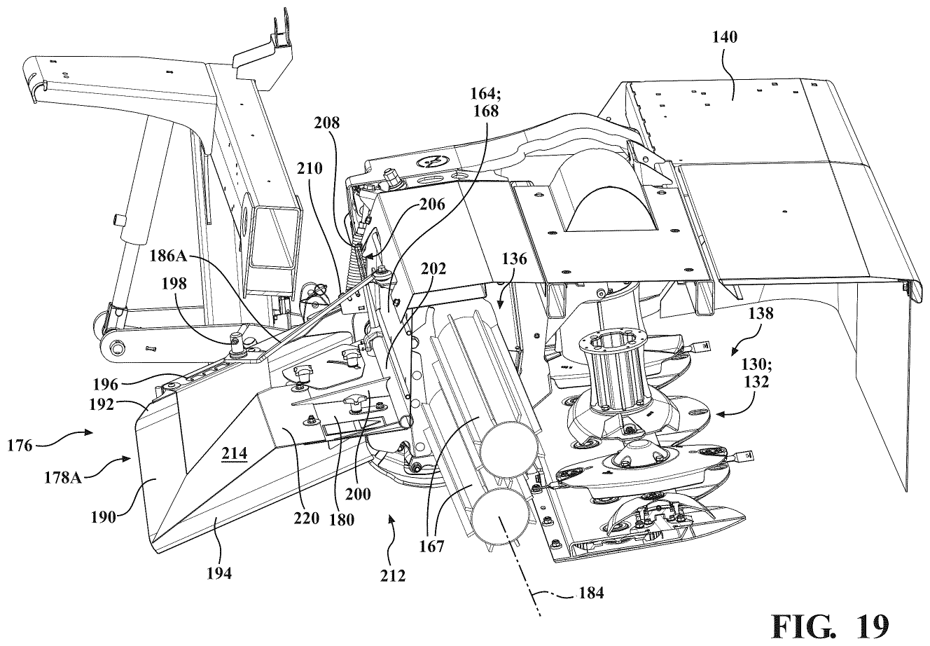

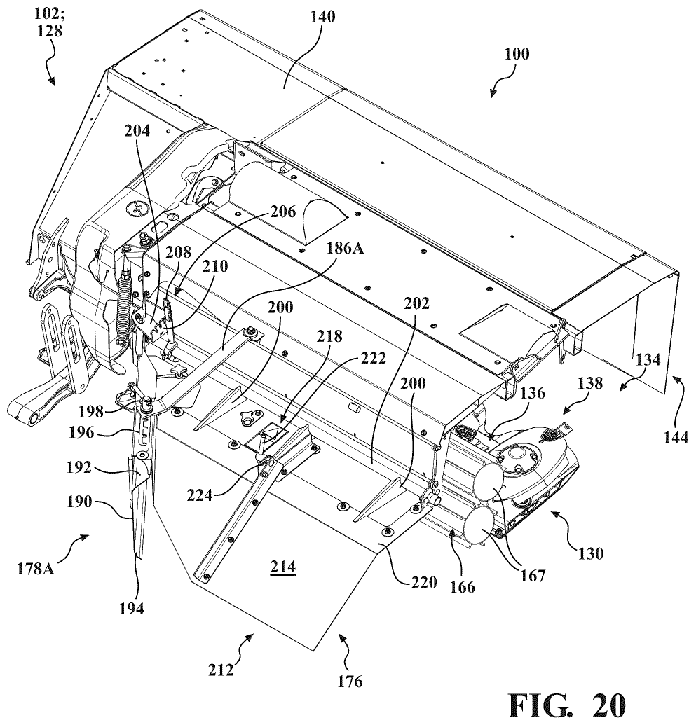

Turning to FIGS. 18-20, details of the height deflector 180 are shown. Similar to above, the discharge shaper 176 may further include a height limiting arm 200. The height limiting arm 200 is coupled to the height deflector 180 and the header frame 128 and configured to adjust the angle of the height deflector 180 relative to the rear discharge wall 164 to control the windrow height 74 of the windrow 70. The height deflector 180 may be constructed from a polymer material such as a rubber or plastic. The rubber material may provide some flexibility to the height deflector 180 to avoid over-compressing the cut crops when forming the windrow 70. Additionally, a rubber material is resistant to damage from impacts during operation.

Here, discharge shaper 176 may include more than one height limiting arms 200 spaced along the height deflector 180 to control the angle. For example, the discharge shaper 176 may include a pair of height limiting arms 200, which are arranged on opposing sides of the centerline of the header frame 128. The discharge shaper 176 may further include a pivot rod 202 coupled to each of the height limiting arms 200 to facilitate pivoting movement of the height deflector 180. The pivot rod 202 is supported for pivoting movement about the lateral axis 184 by a pivot socket 204. The pivot socket 204 is coupled to the rear discharge wall 164 adjacent to the head jamb 168 of the discharge opening 166.

Again, similar to the width deflector 178 above, the height deflector 180 is adjusted by pivoting about the lateral axis 184 varying the angle of the height deflector 180 relative to the rear discharge wall 164. To this end, the height deflector 180 may include a height latch 206 coupled to the pivot rod 202 and engageable with the header frame 128 to control the angle of the height deflector 180. The height latch 206 includes a handle 208 coupled to the pivot rod 202 and operable by a user to move the pivot rod 202 relative to the pivot socket 204. The pivot socket 204 defines a plurality of notches 210 arranged in a radial pattern about the lateral axis 184. The handle 208 is selectively engageable with each of the notches 210 to prevent the handle 208 and pivot rod 202 from pivoting. When the user disengages the handle 208 from the notches 210, the handle 208 is movable to pivot the pivot rod 202 and the height deflector 180 about the lateral axis 184 and adjust the windrow height 74 of the windrow 70. The user engages the handle 208 with one of the notches 210 to prevent pivoting movement of the pivot rod 202 and the height deflector 180 about the lateral axis 184 and set the windrow height 74 of the windrow 70.

The discharge shaper 176 may further include a height shaper 212 coupled to the height deflector 180. The height shaper 212 may cooperate with the height deflector 180 to further control the windrow height 74. The height shaper 212 may include a shaper shield 214, a shaper brace 216, and a shaper latch 218. Here, the height shaper 212 includes more than one shaper brace 216, each coupled to one of the height limiting arms 200. For example, the discharge shaper 176 may include a pair of shaper braces 216, which are arranged on opposing sides of the centerline of the header frame 128. Each shaper brace 216 is pivotably coupled to a distal end of one of the height limiting arms 200 to independently adjust the angle of the shaper shield 214 relative to the height deflector 180. The height shaper 212 may further include more than one shaper latch 218, each of which is coupled to one of the height limiting arms 200 and the corresponding shaper brace 216 to control the angle between the shaper brace 216 and the height limiting arm 200. The shaper latch 218 includes a clamp 222 disposed in an arcuate slot 224. The clamp 222 is configured to move within the arcuate slot 224 as the shaper brace 216 moves relative to the height limiting arm 200 and, when tightened, prevent movement of the shaper brace 216 relative to the height limiting arm 200.

The shaper shield 214 is pivotably coupled at a first end to the height deflector 180 and extends in a generally rearward direction therefrom. The shaper shield 214 is further coupled to each of the shaper braces 216. The shaper shield 214 may also be constructed from a polymer material such as a rubber or plastic. The rubber material may provide some flexibility to the shaper shield 214 to avoid over-compressing the cut crops when forming the windrow 70. Additionally, a rubber material is resistant to damage from impacts during operation. The shaper shield 214 may include a shaper hinge 220 that is coupled to the height deflector 180 to facilitate pivoting movement therebetween. The shaper hinge 220 may be a piano type hinge having two independent portions pivotably supported on a hinge pin. Alternatively, the shaper hinge 220 may be a strip of flexible material having a unitary construction. In another example, the shaper hinge 220 may be integrally formed with the height deflector 180 and the shaper shield 214 as a living hinge.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

What is claimed is:

1. A crop harvesting header operable to form windrows, the crop harvesting header comprising:
a carrier frame configured to be mounted to a tractor;
a header frame movably coupled to the carrier frame and defining a discharge opening on a rear side;
a cutter bar coupled to the header frame and operable to cut crops; and
a discharge shaper assembly coupled to the header frame and comprising:
a height deflector coupled to the header frame adjacent to the discharge opening and pivotable to control a height of a windrow formed from crops ejected through the discharge opening during operation.

2. The crop harvesting header of claim 1, wherein the header frame is arranged forwardly of the carrier frame.

3. The crop harvesting header of claim 1, wherein the discharge shaper assembly further comprises a height latch coupled between the height deflector and the header frame and configured to control the angle of the height deflector relative to the header frame.

4. The crop harvesting header of claim 1, wherein the discharge shaper assembly further comprises a height limiting arm coupled to the height deflector and the header frame and configured to adjust an angle of the height deflector to control a height of discharged crop.

5. The crop harvesting header of claim 1, wherein the discharge shaper assembly further comprises a first width deflector and a second width deflector each pivotably coupled to the header frame adjacent to the discharge opening, wherein the first width deflector and the second width deflector are arranged on opposing sides of the height deflector.

6. The crop harvesting header of claim 5, wherein the discharge shaper assembly further comprises a width limiting arm coupled to the first width deflector and the header frame and configured to adjust an angle of the first width deflector to control a width of discharged crop.

7. The crop harvesting header of claim 5, wherein the first width deflector and the second width deflector each include a wing portion, wherein the wing portion is curved toward the height deflector and configured to facilitate forming the windrows.

8. The crop harvesting header of claim 7, wherein the wing portion of the first width deflector and the second width deflector is further defined as an upper wing portion and a lower wing portion, and wherein the upper wing portion and the lower wing portion cooperate to define a c-shaped profile of each of the first width deflector and the second width deflector.

9. The crop harvesting header of claim 5, wherein the first width deflector and the second width deflector are formed from a flexible material.

10. The crop harvesting header of claim 9, wherein the flexible material is a rubber.

11. The crop harvesting header of claim 1, wherein the height deflector is formed from a flexible material.

12. The crop harvesting header of claim 1, further comprising a pair of conditioner rolls operably coupled to the header frame and arranged adjacent to the discharge opening for ejecting cut crops through the discharge opening.

13. The crop harvesting header of claim 1, wherein the discharge shaper assembly extends rearwardly from the header frame toward the carrier frame.

14. The crop harvesting header of claim 13, wherein the discharge shaper assembly extends rearwardly beyond the carrier frame to a distance further from the header frame than the carrier frame.

15. The crop harvesting header of claim 1, wherein the discharge shaper assembly further comprises a height shaper coupled to the height deflector and pivotable to further control the height of the windrow formed from crops ejected through the discharge opening during operation.

16. The crop harvesting header of claim 15, wherein the discharge shaper assembly further comprises a shaper latch coupled between the height deflector and the height shaper and configured to control the angle of the height shaper relative to the height deflector.

17. The crop harvesting header of claim 15, wherein the discharge shaper assembly further comprises a pair of shaper braces coupled to the height shaper, and wherein the shaper braces are arranged on opposing sides of a centerline of the header frame.

18. The crop harvesting header of claim 15, wherein the height shaper is formed from a flexible material.

19. The crop harvesting header of claim 18, wherein the flexible material is a rubber.
